(19) United States
(12) Patent Application Publication
(10) Pub. No.: US 2026/0185856 A1
(43) Pub. Date: Jul. 2, 2026

(54) HOUSING FOR AN AUTOMATION FIELD DEVICE

(71) Applicant: Endress+Hauser SE+Co. KG, Maulburg (DE)

(72) Inventors: Daniel Kopp, Lörrach (DE); Alexander Meinhardt, Lörrach (DE); Pablo Ottersbach, Essen (DE); Pascal Matt, Lörrach (DE)

(21) Appl. No.: 19/130,462

(22) PCT Filed: Oct. 23, 2023
(86) PCT No.: PCT/EP2023/079410

§ 371 Date: May 15, 2025

(30) Foreign Application Priority Data
Nov. 16, 2022 (DE) 10 2022 130 367.5

(51) Int. Cl. G01D 11/24

(52) U.S. Cl. CPC G01D 11/245

(57) ABSTRACT

A housing including a housing body and a housing lid, wherein the housing body has an opening and defines an inner space accessible through the opening. The housing body is metal and includes a cylindrical region on which the housing lid is placeable, wherein the housing lid and the cylindrical region are attachable without a screwed connection. A plastic ring is located in the opening and fitted at least sectionally to an inner edge of the face of the cylindrical region. The plastic ring is embodied so that a maximum overhang of the plastic ring at least sectionally extends beyond an outer contour defined by the cylindrical region, such that the housing lid is guided by the plastic ring when being placed on the cylindrical region.

The invention relates to a housing, especially a field device housing, and to a field device of automation technology.

In automation technology, especially in process automation technology, field devices are often applied, which serve for determining, optimizing and/or influencing process variables. Serving for registering process variables are sensors, such as, for example, fill level measuring devices, flow measuring devices, pressure- and temperature measuring devices, conductivity measuring devices, etc., which register the corresponding process variables, fill level, flow, pressure, temperature, and conductivity. Serving for influencing process variables are actuators, such as, for example, valves or pumps, via which the flow of a liquid in a pipeline section, or the fill level in a container, can be changed. Referred to as field devices are, in principle, all devices, which are applied near to a process and which deliver, or process, process relevant information. In connection with the invention, the terminology, field devices, includes, thus, also remote I/Os, and, in general, devices, which are arranged at the field level. A large number of such field devices are manufactured and sold by the firm, Endress+Hauser.

Such field devices always have a field device housing composed of a housing body and a housing lid. Usually, the housing body is manufactured from a sheet metal. For attaching the housing lid, in such case, a “marmalade, jam, or jelly glass jar connection” or “bayonet connection” is provided, since, for manufacturing reasons, a metric screw thread cannot be directly provided in the body of sheet metal. Depending on the particular way in which the selected, releasable, mechanical connection is embodied, the guiding of the housing lid is significantly less defined than in case of a metric screw thread. With this less than desired guiding comes the probability that the housing lid rubs and possibly tilts as it is being taken on and off, such that the connection can even be damaged. Furthermore, because of the mechanical rubbing, a higher force is necessary for opening and closing the housing lid.

An object of the invention is, thus, to provide a housing, especially a field device housing, which enables easy opening and closing of the housing lid, without the danger of tilting and/or damage.

The object is achieved according to the invention by the housing, especially the field device housing, as defined in claim 1 and the field device of automation technology as defined in claim 6.

The housing, especially field device housing, of the invention comprises a housing body and a housing lid, wherein the housing body has a pot-like shape with an opening and forms an inner space accessible through the opening, wherein the housing body is formed of metal, preferably a steel, especially preferably a stainless steel, wherein the housing body includes, adjoining and defining the opening, an essentially cylindrical region, on which the housing lid is placeable for closing the housing body, wherein the housing lid and the cylindrical region have means other than a screwed connection for releasable mechanical connection, wherein located in the opening and fitted at least sectionally to an inner contour of the cylindrical region is a plastic ring, which is further embodied in such a manner that it at least sectionally extends out beyond an outer contour at the opening adjoining the cylindrical region, such that the housing lid is guided by the plastic ring when being placed on the cylindrical region.

According to the invention, a plastic ring is provided, which extends laterally out beyond the upper edge of the sheet metal housing and which, thus, has an overhang with a somewhat greater diameter than the opening of the housing. In this way, the lid is guided better centrally and, in given cases, does not rub against the housing, but rather, against the plastic ring. This assures that noise and damaging of the housing and lid are prevented. Since the plastic ring can be manufactured significantly more accurately than the housing made of sheet metal, the centering of the lid is improved by the ring, this, in turn, means that the probability of tilting is decreased.

An advantageous embodiment of the housing, especially the field device housing, of the invention can provide that the plastic ring is embodied in such a manner that a maximum overhang of the plastic ring, with which the plastic ring extends at least sectionally out beyond the outer contour at the opening adjoining the cylindrical region amounts to no more than 0.5 mm, preferably no more than 0.4 mm, quite especially preferably no more than 0.3 mm.

Another advantageous embodiment of the housing, especially the field device housing, of the invention can provide that the plastic ring is embodied in such a manner that a minimum overhang of the plastic ring, with which the plastic ring extends, at least sectionally, out beyond the outer contour at the opening adjoining the cylindrical region amounts to at least 0.1 mm, preferably at least 0.2 mm, quite especially preferably at least about 0.25 mm.

Another advantageous embodiment of the housing, especially the field device housing, of the invention can provide that the cylindrical region of the housing body includes on an outer surface a plurality of, preferably equidistantly arranged relative to one another, radially protruding, bayonet projections, by which the housing lid can by means of a rotational movement be locked in a closed position and wherein the plastic ring is embodied in such a manner that the plastic ring extends out at least beyond the outer contour of the protruding bayonet projections of the cylindrical region.

Another advantageous embodiment of the housing, especially the field device housing, of the invention can provide that the plastic ring is embodied in such a manner that it is releasably connectable with the housing body via a clip connection, and, thus, releasably clippable, or snappable, in the housing body.

The invention relates further to a field device of automation technology having a housing, especially a field device housing, according to one of the above described embodiments.

The invention will now be explained in greater detail based on the appended drawing, the figures of which show as follows:

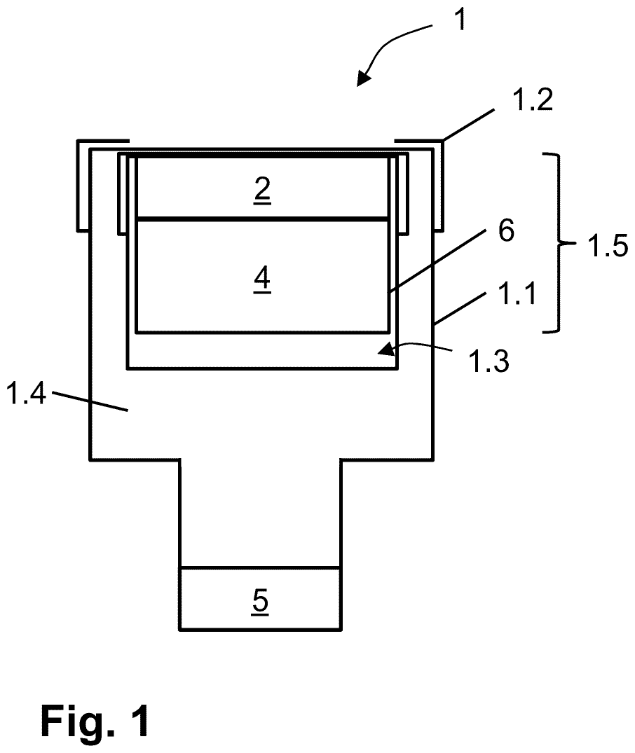

FIG. 1 a schematic view of a field device of automation technology,

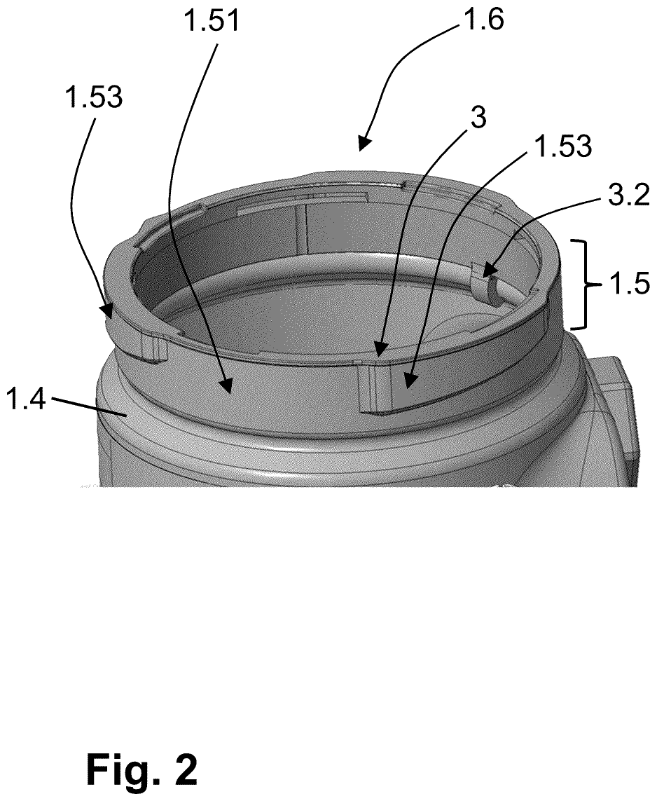

FIG. 2 a perspective view of the housing body at an opening defined by a cylindrical region of the housing body with a plastic ring of the invention, and

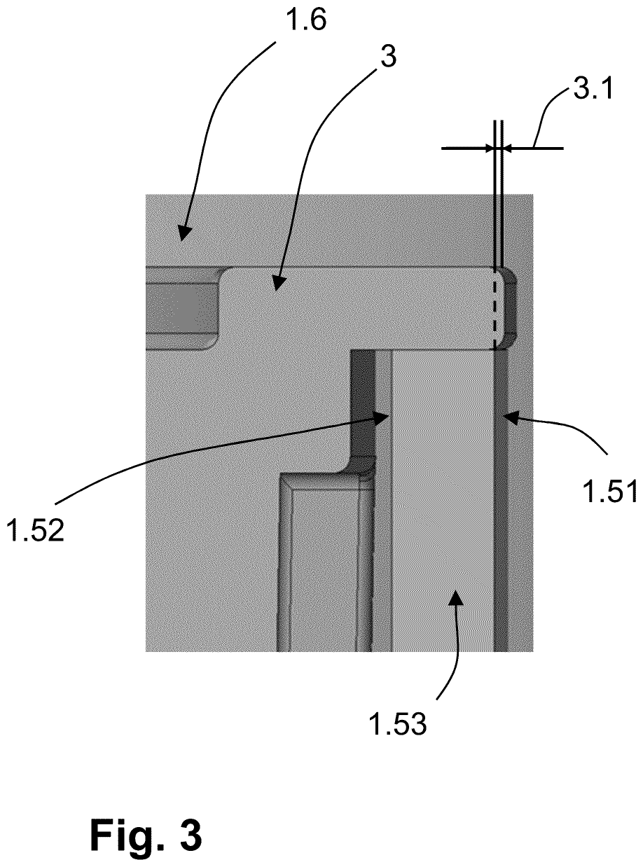

FIG. 3 a sectional view of a plastic ring formed according to the invention in the region of the overhang.

FIG. 1 shows, schematically, a usual construction of a field device 1 of automation technology. Field device 1 includes a housing 1.1 having a housing lid 1.2 and a housing body 1.4. Housing body 1.4 is produced from a sheet metal, preferably a steel sheet metal, especially preferably a stainless steel sheet metal, such as, for example, 316L. Housing body 1.4 has an essentially pot-like shape with a floor and an opening, through which an inner space 1.3 is accessible. The cross sectionally essentially round opening 1.6, is defined and formed by a cylindrical region 1.5 of the housing body 1.4. Additionally, the field device 1 further includes a sensor- and/or actuator element 5 arranged on or in the housing 1.1 for setting and/or registering a process variable as well as, located in the inner space 1.3, a field device electronics 4, which, among other things, is embodied to operate the sensor- and/or actuator element 5.

In order to enable servicing/parametering of the field device 1 and/or to display information, e.g., with reference to the process variable to be registered or to be set, the field device 1 can have an interaction- and/or display element 2. Interaction- and/or display element 2 can, such as shown in FIG. 1, be integrated in the housing lid 1.2 of the field device or inserted in a housing wall of the housing body 1.4.

Alternatively, the interaction- and/or display element 2 can also be secured on an outside of the housing wall. In the case, in which the field device 1 includes an interaction- and/or display element 2, the field device electronics 4 can also be adapted to drive, thus correspondingly to operate, the interaction- and/or display element 2.

FIG. 2 shows a perspective view of the housing body 1.4 at an opening 1.6 defined by a cylindrical region 1.5 of the housing body 1.4 with a plastic ring 3 of the invention provided in the opening. The cylindrical region 1.5 of the housing body 1.4 is embodied on an outer surface 1.51 in the present example in such a manner that provided there are three radially protruding, bayonet projections 1.53 (of which only two are visible in FIG. 2), by which the housing lid 1.2 can by means of rotational movement be locked in a closed position. In the example of an embodiment, the radially protruding bayonet projections 1.53 are arranged equidistantly from one another on the outer surface 1.51 of the cylindrical region 1.5.

According to the invention, a plastic ring 3 is located in the opening 1.6 of the housing body 1.4. The plastic ring 3 is formed in such a manner that it is fitted to an inner contour 1.52 of the cylindrical region 1.5, i.e., lies snugly against the cylindrical region. In such case, the plastic ring 3 does not need to contact the cylindrical region snugly over the full 360°, but, instead, can also sectionally snugly not contact, especially at the sites, where the radially protruding bayonet projections 1.53 are located. The plastic ring 3 is formed in such a manner that it at least sectionally and radially extends out beyond an outer contour at the opening 1.6 adjoining the cylindrical region 1.5.

FIG. 3 shows a sectional view through a plastic ring 3 formed according to the invention in the region of the overhang 3.1 for more detailed description of the overhang 3.1, with which the plastic ring 3 extends, at least in the region bayonet projections 1.53, radially out beyond the outer contour at the opening 1.6. Proved as especially preferable, in such case, is a maximum overhang 3.1, with which the plastic ring 3 extends out beyond the outer contour, of no more than 0.5 mm, preferably no more than 0.4 mm, quite especially preferably no more than 0.3 mm. Proved as especially preferable as regards a minimum overhang 3.1 is an overhang 3.1 of at least 0.1 mm, preferably at least 0.2 mm, quite especially preferably at least 0.25 mm.

Additionally, the plastic ring 3 can have one or preferably more holding- and/or clip elements 3.2 for the releasable connecting, thus releasable clipping, of the plastic ring 3 in the housing body. The holding- and/or clip elements 3.2 are, in turn, equidistantly arranged relative to one another. Furthermore, the holding- and/or clip elements 3.2 can be formed in such a manner that they are pluggable over, thus clippable, or snappable, over an inwardly extending bead, or ridge, 1.7 of the housing located at the lower end of the cylindrical region.

### LIST OF REFERENCE CHARACTERS

1 field device
1.1 field device housing
1.2 lid of the field device housing
1.3 inner space of the field device housing
1.4 housing body
1.5 cylindrical region
1.51 outer surface, or outer contour, of the cylindrical region
1.52 inner surface, or inner contour, of the cylindrical region
1.53 bayonet projection
1.6 opening of the field device housing
1.7 inwardly extending bead, or ridge, of the housing
2 interaction- and/or display element
2.1 pane
3 support ring
3.1 overhang
3.2 holding- and/or clip element
4 electronics, or electronic circuit
5 sensor- and/or actuator element
6 connecting element

1-6. (canceled)

7. A housing comprising a housing body and a housing lid, wherein the housing body is metal with a pot-like shape and defines an inner volume accessible through an opening of the housing body;
wherein the housing body includes an essentially cylindrical region, which adjoins and diametrically defines the opening and on which the housing lid is placeable to close the inner volume of the housing body;
wherein the housing lid and the cylindrical region can be reversibly mechanically connected without a screwed connection;
wherein a plastic ring is disposed in the opening and fitted at least sectionally to an inner contour of the cylindrical region, the plastic ring embodied so as to, at least sectionally, extend beyond an outer contour of the cylindrical region adjoining the opening;
wherein the plastic ring is configured to guide the housing lid when the housing lid is placed on the cylindrical region.

8. The housing of claim 7, wherein the plastic ring is embodied such that a maximum overhang of the plastic ring, with which the plastic ring extends at least sectionally beyond the outer contour of the cylindrical region, is not more than 3 mm.

9. The housing of claim 7, wherein the plastic ring is embodied such that a minimum overhang of the plastic ring, with which the plastic ring at least sectionally extends beyond the outer contour of the cylindrical region, is at least 0.1 mm.

10. The housing of claim 1, wherein the outer surface of the cylindrical region of the housing body includes a plurality of radially protruding bayonet projections, wherein the bayonet projections are embodied to reversibly mechanically connect the housing lid to the cylindrical region of the housing body, wherein housing lid can be locked in a closed position via rotational movement, and
wherein the plastic ring at least sectionally extends beyond an outer contour of the protruding bayonet projections.

11. The housing of claim 1, wherein the plastic ring is embodied to be reversibly connectable with the cylindrical region of the housing body via a clip connection, such that the plastic ring is reversibly clippable or snappable to the housing body.

12. A field device for automation technology comprising the housing of claim 1.

13. The housing of claim 7, wherein the housing houses a field device.

14. The housing of claim 7, wherein the housing body is formed of steel.

15. The housing of claim 7, wherein the housing body is formed of stainless steel.

16. The housing of claim 8, wherein the plastic ring is embodied such that a maximum overhang of the plastic ring, with which the plastic ring extends at least sectionally beyond the outer contour of the cylindrical region, is not more than 2.5 mm.

17. The housing of claim 8, wherein the plastic ring is embodied such that a maximum overhang of the plastic ring, with which the plastic ring extends at least sectionally beyond the outer contour of the cylindrical region, is not more than 2.0 mm.

18. The housing of claim 9 more than 0.2 mm.

19. The housing of claim 9, wherein the plastic ring is embodied such that a maximum overhang of the plastic ring, with which the plastic ring extends at least sectionally beyond the outer contour of the cylindrical region, is more than 0.25 mm.

20. The housing of claim 10, wherein the radially protruding bayonet projections are equidistantly arranged from one another.
